(19) United States
(12) Patent Application Publication
(10) Pub. No.: US 2026/0099697 A1
(43) Pub. Date: Apr. 9, 2026

(54) EXPERT SELECTION FROM MIXTURE OF EXPERTS IN LARGE LANGUAGE MODELS

(71) Applicant: Samsung Electronics Co., Ltd., Suwon-si (KR)

(72) Inventors: Usman SAJID, San Jose, CA (US); Marie Mai NGUYEN, Pittsburgh, PA (US); Shuyi PEI, Santa Clara, CA (US); Younghoon KIM, San Diego, CA (US); Rekha PITCHUMANI, Herndon, VA (US)

(21) Appl. No.: 19/347,703

(22) Filed: Oct. 1, 2025

Related U.S. Application Data
(60) Provisional application No. 63/703,897, filed on Oct. 4, 2024.
(60) Provisional application No. 63/703,898, filed on Oct. 4, 2024.

(51) Int. Cl. G06N 3/045; G06N 3/0499

(52) U.S. Cl. CPC G06N 3/045; G06N 3/0499

(57) ABSTRACT

A system and a method for a machine learning (ML) model with expert selection are disclosed. The model includes a global selector and a pre-fetcher. The global selector is configured to manage a selection scheme having at least one of a global mode or a local mode. In the global mode, the global selector selects a global expert set from a mixture of experts (MoE) to generate a selected global expert set for each layer prior to an inference phase in the ML model. The pre-fetcher is configured to pre-fetch in the global mode the selected global expert set from a first memory into a second memory. The selected global expert set includes one or more global hot experts.

### CROSS-REFERENCE TO RELATED APPLICATION

This application claims the priority benefit under 35 U.S.C. § 119(e) of U.S. Provisional Patent Application Ser. No. 63/703,897 filed on Oct. 4, 2024, and U.S. Provisional Patent Application Ser. No. 63/703,898 filed on Oct. 4, 2024, the disclosures of which are incorporated by reference in their entirety as if fully set forth herein.

### TECHNICAL FIELD

The disclosure generally relates to artificial intelligence (AI). More particularly, the subject matter disclosed herein relates to mixtures of experts (MoE) in large language models (LLMs).

### BACKGROUND

The present background section is intended to provide context only, and the disclosure of any concept in this section does not constitute an admission that said concept is prior art.

Large Language Models (LLMs) have progressed from early language-processing techniques to become sophisticated AI systems reshaping digital communication and content creation. The transformer architecture marked a turning point for LLMs, as it allowed models to capture complex dependencies and context in text efficiently. As AI applications have become more and more popular, the size and complexity of training datasets have also been scaled up significantly. The mixture-of-experts (MoE) architecture attempts to reduce the up-scaling effect of the machine learning (ML) models with increasingly large training datasets. However, the MoE architecture is inefficient in terms of memory utilization and creates difficulties in training and fine tuning.

Existing techniques for solving the memory utilization and other difficulties with the MoE architecture has a number of drawbacks. Examples of these drawbacks include inflexibility to accommodate the dynamic nature of ML architectures and inefficient utilization of computational resources such as memory.

The above information disclosed in this Background section is only for enhancement of understanding of the background of the disclosure and therefore it may contain information that does not constitute prior art.

### SUMMARY

To overcome these issues, systems and methods are described herein for a technique of selecting experts in a ML model. A selection scheme includes a global mode, a local mode, and a mixed mode. A selection circuit performs the selection scheme. In the global mode, the selection circuit includes a global selector and a pre-fetcher. The global selector is configured to manage a selection scheme having at least a global mode. In the global mode, the global selector selects a global expert set from a mixture of experts (MoE) to generate a selected global expert set for each layer prior to an inference phase in the ML model. The pre-fetcher is configured to pre-fetch in the global mode the selected global expert set from a first memory into a second memory. The selected global expert set includes one or more global hot experts.

In the local mode, each layer selects a local expert set from the MoE to generate a selected local expert set in the inference phase. The selected local expert set includes one or more local hot experts. The pre-fetcher prefetches the selected local expert set for the each layer for the entire layer set from the first memory into the second memory prior to the inference phase. In the mixed mode, each layer selects one of the global expert set or the local expert set for each layer according to a selection flag associated with the each layer to generate a selected one of the global expert set or the local expert set for the each layer prior to the inference phase. The pre-fetcher prefetches the selected one of the global expert set or the local expert set for the each layer for the entire layer set from the first memory into the second memory prior to the inference phase.

### BRIEF DESCRIPTION OF THE DRAWINGS

In the following section, the aspects of the subject matter disclosed herein will be described with reference to exemplary embodiments illustrated in the figures, in which:

FIG. 1 is a block diagram illustrating a system that utilizes a large language model (LLM) with MoE according to an embodiment.

FIG. 2 is a diagram illustrating a layer that utilizes a feedforward neural network with MoE according to an embodiment.

FIG. 3 is a diagram illustrating an MoE according to an embodiment.

FIG. 4 is a diagram illustrating an expert selector according to an embodiment.

FIG. 5 is a diagram illustrating an expert selection with a global mode according to an embodiment.

FIG. 6 is a diagram illustrating an expert selection with a local mode according to an embodiment.

FIG. 7 is a diagram illustrating an expert selection with a mixed mode according to an embodiment.

FIG. 8 is a diagram illustrating a pre-fetch process according to an embodiment.

FIG. 9 is a flow chart illustrating a process of expert selection according to an embodiment.

FIG. 10 is a flow chart illustrating the process of expert selection in a global mode according to an embodiment.

FIG. 11 is a flow chart illustrating the process of expert selection in a local mode according to an embodiment.

FIG. 12 is a flow chart illustrating the process of expert selection in a mixed mode according to an embodiment.

FIG. 13 is a diagram illustrating a processing system according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements. In the following, figures depicting various components, structures, interconnections, configurations, and steps of fabrication, are mainly for illustrative purposes. They are not intended to describe these elements accurately. A cross-sectional representation may be used to refer to a 3D block in a 3D structure. In some cases, relevant parts in a figure are shown clearly while other parts are shown with less sharpness or clarity to avoid confusion and improve contrast and clarity. These parts may be referenced in earlier figures and therefore do not need to be described again. These parts may also have little relationship with the part(s) being described. In addition, the shading of the parts in the figures may not have a consistent design and may be changed to maintain clarity and contrast in the figures. For example, part A may have a light shading in Fig. X but may be heavily shaded in Fig. Y. Moreover, as mentioned above, components in a figure may not be drawn with proper scales.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

The term “expert,” as used herein in the context of machine learning (ML) and large memory models (LLM), refers to a subnetwork in a larger model of neural networks which has been trained to become proficient or perform well in a specialized field of knowledge or function. The subnetwork may be a feedforward neural network (FFNN) or any suitable learning network. An expert may be activated to perform its function or deactivated to stop functioning. A “mixture of experts (MoE),” as used herein, refers to a collection of the experts as defined above. An MoE may include “hot experts” and “cold experts.” A “hot expert” refers to an expert whose performance is “hot” or meeting desirable or performance criteria. A “cold expert” refers to an expert whose performance is cold or not meeting desirable performance criteria.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In some embodiments, a system and a method for a machine learning (ML) model with expert selection are disclosed. The model includes a selection scheme which provides selection of one of three modes: global mode, local mode, and mixed mode. In the global mode, the model includes a global selector and a pre-fetcher. The global selector is configured to manage a selection scheme having at least a global mode. In the global mode, the global selector selects a global expert set from a mixture of experts (MoE) to generate a selected global expert set for each layer prior to an inference phase in the ML model. The pre-fetcher is configured to pre-fetch in the global mode the selected global expert set from a first memory into a second memory. The selected global expert set includes one or more global hot experts. In the local mode, each layer selects a local expert set from the MoE to generate a selected local expert set in the inference phase. The selected local expert set includes one or more local hot experts. The pre-fetcher prefetches the selected local expert set for the each layer for the entire layer set from the first memory into the second memory prior to the inference phase. In the mixed mode, each layer selects one of the global expert set or the local expert set to generate a selected one of the global expert set or the local expert set for each layer according to a selection flag associated with the each layer prior to the inference phase.

The proposed technique offers a flexible and efficient co-design architecture for the LLM using MoE. The three selection modes provide flexibility in using MoE to accommodate the dynamic nature of ML architectures. In addition, the pre-fetching mechanism provides an efficient utilization of computational resources such as memory.

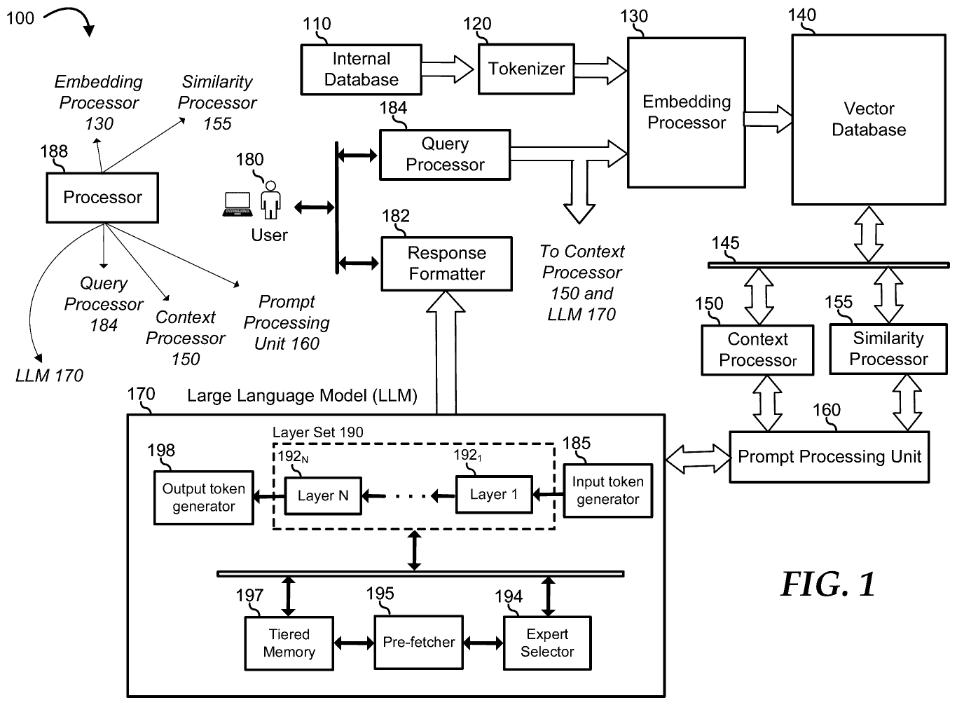

FIG. 1 is a block diagram illustrating a system 100 that utilizes a large language model (LLM) with MoE according to an embodiment. The system 100 includes an internal database 110, a tokenizer 120, an embedding processor 130, a vector database 140, a connectivity link 145, a context processor 150, a similarity processor 155, a prompt processing unit 160, a large language model (LLM) 170, a response formatter 182, a query processor 184, and a user 180. The system 100 may include more or less than the above components. The system 100 illustrates an exemplary architecture of an artificial intelligence (AI) query-and-response application. This query-and-response application receives queries from the user 180 and provide the response using the LLM 170. This type of application may be implemented by hardware or software or a combination of both. The reason why this application is used as an example to illustrate the role of the expert selection is that it uses a very large computational resources including large storages for data and high computations. Whether it is implemented by hardware, software, or a combination of both, the basic component of the system is an processor or processing system 188 that is used in any functional unit that needs computational and/or storage power such as the tokenizer 120, the embedding processor 130, the context processor 150, the similarity processor 155, the prompt processing unit 160, the LLM 170, the response formatter 182, and the query processor 184. Some of the components may be parts of other components. For example, the tokenizer 120 and the embedding processor 130 may be parts of the LLM 170.

The internal database 110, as opposed to the vector database 140, is a database that stores data or information that is private to an organization and is not available publicly. In contrast, the vector database 140 stores data or information that is available publicly. The term “internal” refers to the nature of the database, not its physical attribute. The query session may be used by an employee of a company and therefore the data may be private or proprietary to the company. The internal database 110 may not be needed if the query is for public information. The tokenizer 120 processes the data from the internal database 110 and prepares for use in subsequent stages. A typical input is a text or a sentence. The tokenizer 120 breaks the text into smaller units, called tokens, which may be a word or a phrase, or a form that can be processed by other units. Typically, this task may include extracting relevant information from the text and represent this information by meaningful numbers. This may be performed by a special program, or a special circuit which may be implemented in an applications-specific integrated circuit (ASIC). Such an ASIC would need to have fast access to memories which store the texts and the tokens. An ASIC with direct access to a storage element in the same package is useful for this purpose.

The embedding processor 130 operates on the output of the tokenizer and the query processor to convert this textual representation into a numeric representation that follows some predefined format. The embedded representation typically has several fields of numbers which may correspond to relevance, relationship, or any characteristics that are useful for processing. These embedded representations typically form vectors. For example, the textual representation “I love New York” may be embedded into a vector having five fields: [0.312, −7.215, 3.126, −0.015, 2.761]. The embedding process may be implemented in hardware using the processor 188. The resulting vectors may be stored in the vector database 140 or may be processed with data read from the vector database 140. The vector database 140 stores vectors that represent domain knowledge and/or the query. The output of the vector database 140 may be passed to the context processor 150 and the similarity processor 155 via the connectivity link 145 for further processing. The connectivity link 145 may be a bus, a network connection, or any medium that allows data transfers between the vector database 140 and other devices including the context processor 150 and the similarity processor 155

The context processor 150 provides contextual information to the query or queries. It receives query information from the query processor 184. The contextual information expands the meaning of the query or queries to include information that is relevant to the content of the query or queries and/or user's background and experience. For example, the queries “What is the capital of California?” “What to do in Central California?” and “Where is Yosemite?” may create a context of traveling. This context will obtain vectors that are related to traveling in California including lodging information and attractions. The context processor 150 therefore requires fast computation to perform searches and matching. It also needs a large memory space to store data. The similarity processor 155 performs matching of candidate vectors to the query vector or vectors to locate the vectors that are most relevant to the query. Depending on the format of the query, an appropriate similarity measure may be determined. For example, for vectors with many numerical values, a cosine similarity may be used. This similarity measure requires calculating an inner product and magnitudes of two vectors. When searching for relevant vectors, thousands of such computations may be performed. This number of computations necessitates an ASIC dedicated for similarity computations. Accordingly, the similarity processor 155 may be efficiently implemented by the processor 188 that includes computational elements in forms of ASIC chiplets for fast and parallel computations. In addition, it should also have a large memory capacity to provide fast access to the vectors. Both the context processor 150 and the similarity processor 155 would also need efficient input/output (IO) circuits to perform fast data transfers to and from the vector database 140 and the prompt processing unit 160.

The prompt processing unit 160 receives results from the context processor 150 and the similarity processor 155 to further provide guidance to steer the LLM 170 to the appropriate direction. Due to the amount of vast information processed by the LLM 170, there is a good chance that the LLM 170 strays into off topic areas, referred to as hallucinations. The prompt processing unit 160 narrows down the search space, based on the contextual information from the context processor 150 and the candidate vectors from the similarity processor 155 and additional information such as user's profile, background, or experience. The prompt processing unit 160 may import domain-specific knowledge data to generate proper directions for the query. It may interact with the context processor 150 and the similarity processor 155 in generate prompts to the LLM 170. Accordingly, it would need a highly integrated package or processing system such as the processor 188 with ASIC chiplets and localized memory and IO or interface circuits.

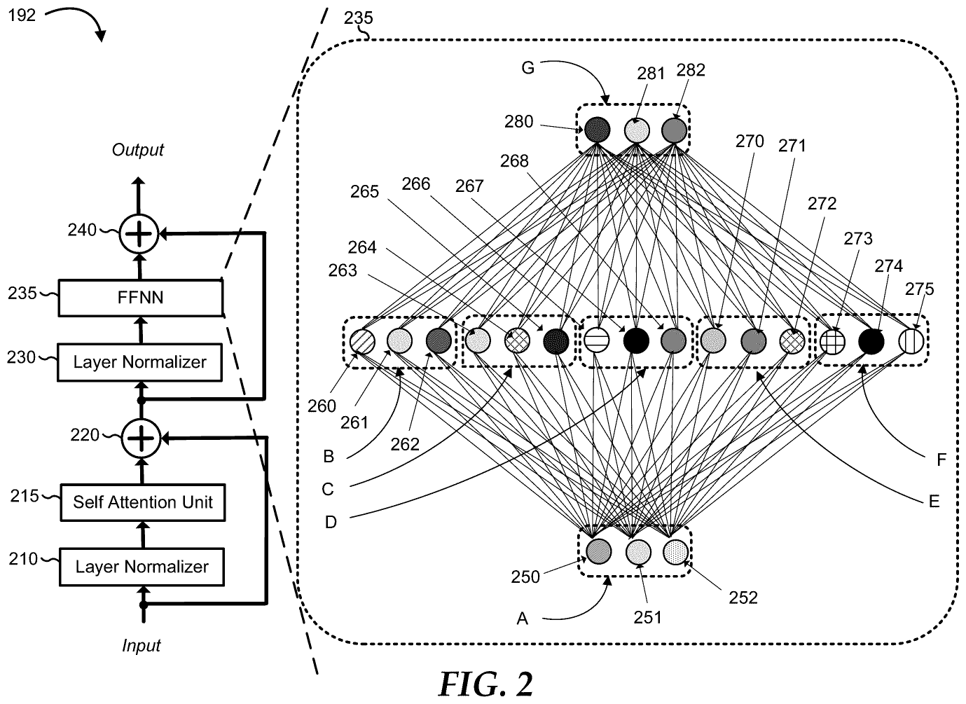

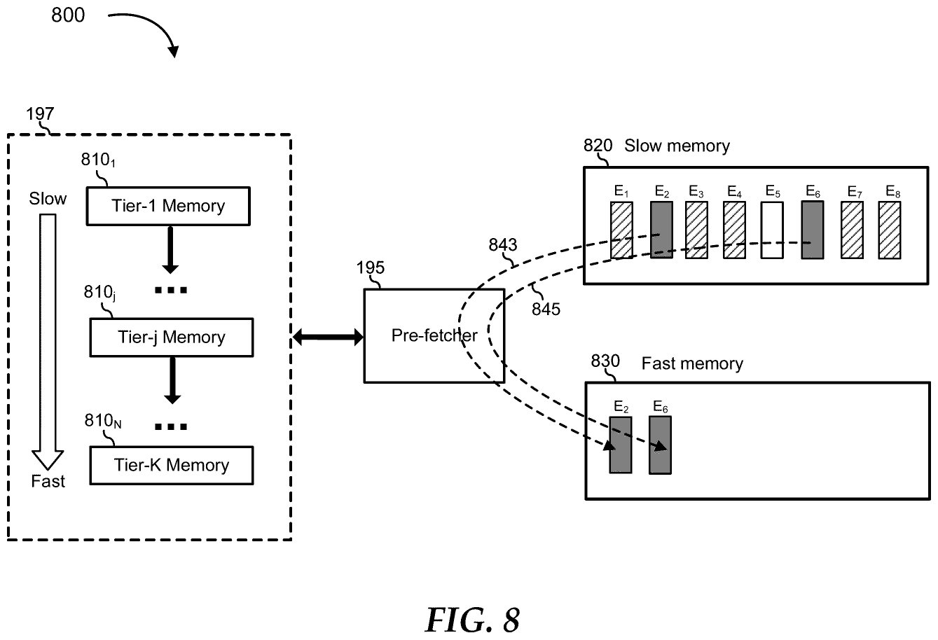

The LLM 170 obtains results from the prompt processing unit 160 including those of the context processor 150 and the similarity processor 155 to generate a response to the query. It also receives query information from the query processor 184. The LLM 170 includes a transformer model having computations that are partly offloaded to the tokenizer 120, the embedding processor 130, the context processor 150, and the similarity processor 155. It includes an encoder and decoder structure to create and process a contextualized representation of the query, a training model to learn the meaning of the query and process the query, an inference engine to reason for a proper response, and a fine-tuning structure to refine the responses based on the results of the context processor 150 and the similarity processor 155. Typically, the LLM 170 involves a massive amount of memory space and computations. Many of the computations may be performed in parallel where there is little or no dependency. In some embodiments, the LLM 170 includes an input token generator 185, a layer set 190, an output token generator 198, an expert selector 194, a pre-fetcher 195, and a tiered memory 197. The LLM 170 may include more or less than the above components. For example, the tiered memory 197 may be located fully or partially outside the LLM 170. In addition, components may be shared or integrated to other components. The input token generator 185 generates the input tokens to be formatted and sent to the layer set 190. It may share the functions with the tokenizer 120. The layer set 190 is a set of N layers 192₁ to 192_{N} where N is a positive integer. For brevity, the subscript may be dropped. The N layers are connected sequentially. The output of one layer is connected to the input of the next layer. The output of the input token generator 185 is connected to the input of the first layer 192₁ and the output of the last layer 192_{N} is connected to the output token generator 198. The layer 192 is described in more details in FIG. 2. The output token generator 198 receives the result from the last layer 192_{N} and generates and formats the result output. It may perform some of the work by the response formatter 182. The expert selector 194 selects an expert set to be used in the inference phase of the LLM 170. In some embodiments, the expert selector 194 may perform functions such as gating and load balancing to dynamically route the input tokens to the relevant experts. The selected experts may be static or dynamic based on the input data. The method of having the global, local, and mixed modes for expert selection, however, is not affected by whether the experts are fixed or dynamically changed. The pre-fetcher 195 prefetches the experts with the tiered memory 197. The tiered memory 197 includes various tiers of memory with different levels of performance, density, and cost. In some embodiments, it may include slow memories such as double data rate dynamic random access memory (DDRDRAM), lower power DDR (LPDDR) and fast memories such as High Bandwidth Memory (HBM). In some embodiments, the pre-fetcher fetches data or experts from a slow memory and store them in a fast memory prior to the processing or inference task. That way, when the processing or inference begins, it can access the experts or data quickly, enhancing the speed. The pre-fetching is described further in FIG. 8.

The LLM 170 typically generates information or data based on user's inputs and prompts from the query processor 184 and the prompt processing unit 160. In some embodiments, there are two operational phases for the LLM 170: summarization and inference. In the summarization phase, the LLM 170, with the assistance of the query processor 184 and others, summarizes the query and formats into input tokens to be processed in the inference phase. In the inference phase, the LLM 170 activates the inference mechanism which may include a series of encoders and decoders within a transformer architecture and generates new information or textual data based on the learning process. The transformer architecture may include encoders and decoders, or only decoders, depending on the applications. Each layer 192ⱼ (j=1, . . . , N) includes a feedforward neural network (FFNN) to perform inference from the input tokens. The FFNN may include several subnetworks that have been trained to become proficient in processing particular sets of input tokens. The subnetworks will be referred to as experts. During the inference phase, only relevant experts are used or activated. The non-experts are deactivated. The relevant experts are selected and referred to as hot experts and the non-selected experts are referred to as cold experts. The selection and generation of experts are done during a configuration or initialization period, prior to the inference phase.

The response formatter 182 receives one or more responses from the LLM 170. These responses correspond to the user query or queries. The response formatter 182 formats these responses in proper format and presentation style which may include graphics and animation. The result is then delivered to the user 180. Due to the amount of computations and IO interactions, the response formatter 182 is best implemented by a highly integrated package like the processor 188 which may include a central processing unit (CPU), a graphics processing unit (GPU), memory, and IO circuits.

The query processor 184 processes the query from the user 180. This process may include tokenization as done by the tokenizer 120 and other formatting operations to convert the user's query into a form that can be further processed. The results of the query processor 184 are delivered to the embedding processor 130, the context processor 150, and the LLM 170. Though the computations in the query processor 184 may or may not be extensive, it often needs fast processing time and specialized procedures. Accordingly, the query processor 184 is best implemented by a highly integrated packages such as the processor 188.

The user 180 may be any user of the system and may include an individual, a team of people, or a computerized process. The user 180 may have a query that is in the public domain and expect the results to be obtained from the public domain. The user 180 may also be a user who has a private query that is particularized for the platform the user 180 is using. For example, the user 180 may be an individual who is interested in knowing the products offered by a company XYZ. As another example, the user 180 may belong to an organization such as a union or an association who want to query a particular subject that is relevant only to that organization. Under this private setting, the internal database 110 is relevant.

The system 100 is an example that illustrates the role of LLM with MoE in high computing (HC) platforms. In many cases, the environment of the applications adds additional requirements including low power consumption, reliable signal integrity, fault-tolerance, and reliable operations in extreme conditions including heat and tight space. Examples of other applications that would benefit from an LLM with MoE architecture include mobile communication (e.g., smart phones, base stations, user equipment), cameras, vehicles, entertainment (e.g., games, multimedia, music, movies), technical designs (e.g., animation, graphics), medical (e.g., visualization, medical imaging), robotics, drones, automatic test equipment, audio processing, speech synthesizer, video and image analysis, vision, automatic face recognition.

FIG. 2 is a diagram illustrating the layer 192 shown in FIG. 1 that utilizes a feedforward neural network (FFNN) with MoE according to an embodiment. The layer 192 is an example of a transformer architecture that processes data or sentences in parallel and captures context and relationships between words and sentences to generate new text or data. The layer 192 include a first layer normalizer 210, a self-attention unit 215, a first combiner 220, a second layer normalizer 230, an FFNN 235, and a second combiner 240. The layer 192 may include more or less than the above components.

The first layer normalizer 210 normalizes the input data to scale them within a stable and balanced range. This may be done by standardizing the data with the mean and standard deviation of the data, followed by scaling and shifting to an appropriate range. The self-attention unit 215 weighs the significance or importance of words or tokens by calculating an attention score representing their relevance to another. The self-attention unit 215 helps the layer 192 understand the relevance of a word or phrase with another word or phrase and provides deeper context to the meaning of the words or phrases. The first combiner 220 combines the value vectors representing the relevance of the input sequence by adding the weighted components of the self-attention unit 215 and the input. The second layer normalizer 230 normalizes the combined vectors from the first combiner 220. The FFNN 235 applies a non-linear transformation to the normalized output of the second normalizer 230. Since the output of the second normalizer 230 corresponds to the result of the self-attention process, the FFNN 235 enriches the data representation and increases the model's understanding of the semantics of the textual data. The second combiner 240 combines the value vectors representing the enriched representation of the input sequence with the representation of the self-attention unit to produce the output. If the layer 192 is not the last layer (i.e., 192_{N}), the output will go to the next layer. If the layer 192 is the last layer (i.e., 192_{N}), the output will go to the output token generator 198. The use of multiple layers that are cascaded in a sequence allows refining of the representation so that nuances in the context can be captured.

As the processing progresses with more and more training data, the FFNN 235 becomes more and more specialized and self-transforms into groups of subnetworks that are devoted to processing a specialized knowledge domain or function. Examples of such specialized domain or function may be “punctuations,” “hiking trails in California,” “travel destinations in Far East,” “scientific fields,” etc. Each subnetwork that has been trained to provide result within a specific domain is called an expert. FFNN 235 therefore includes a number of experts, referred to as a mixture of experts (MoE). The FFNN 235 is expanded to show the MoE. Each subnetwork or expert may have same or difference sizes. For illustrative purposes, the figures show these experts to have the same size.

The FFNN 235 includes three component vectors: the input vector, the hidden vector, and the output vector. The three component vectors form two non-linear transformations that essentially include matrix multiplication of the vector components with corresponding weights. Each vector component is referred to as a neuron having an activation function that operates on the data. The input vector includes three neurons 250, 251, and 252 that forms a block A. The hidden vector includes fifteen neurons that form five blocks B, C, D, E, and F. Each block includes three neurons. These numbers are merely illustrative. Block B includes neurons 260, 261, and 262. Block C includes neurons 263, 264, and 265. Block D includes neurons 266, 267, and 268. Block E includes neurons 270, 271, and 272. Block F includes neurons 273, 274, and 275. The output vector includes block G having three neurons 280, 281, and 282. During training, the weights are updated and adjusted in the back propagation path and the blocks become specialized. As the processing goes through the N layers, the blocks become more and more specialized. The specialization may be different from one layer to the next. In other words, the components of the experts in a layer may be different from the components of the experts in another layer.

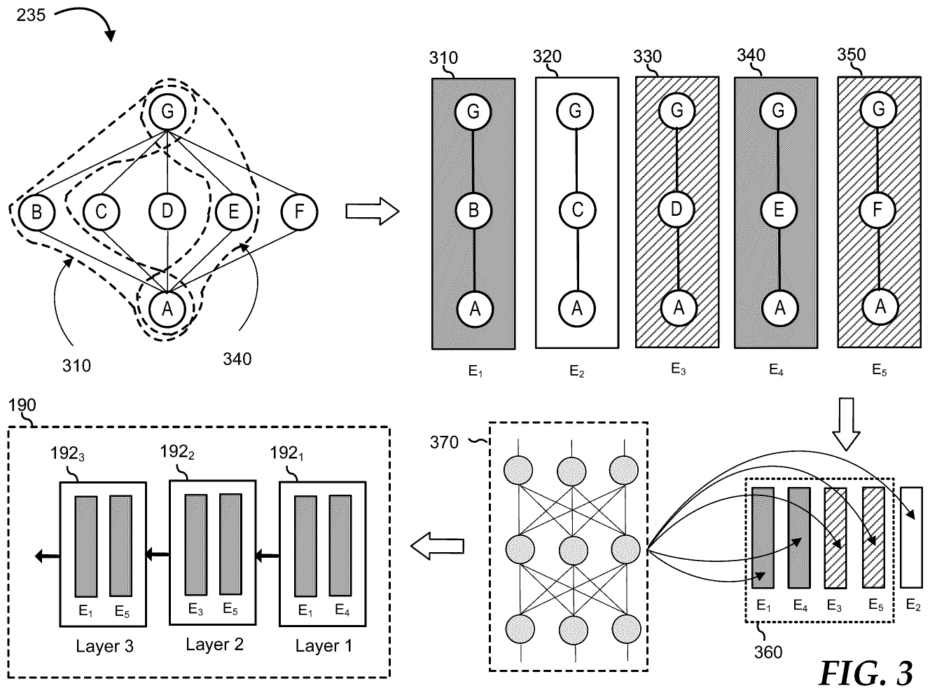

FIG. 3 is a diagram illustrating an MoE of the FFNN 235 shown in FIG. 2 according to an embodiment. For clarity, the FFNN 235 is shown with blocks. The FFNN 235 includes the input block A, the hidden blocks (B, C, D, E, and F), and the output block G.

The blocks form subnetworks 310, 320, 330, 340, and 350. Each subnetwork is an expert. The subnetworks 310, 320, 330, 340, and 350 forms the experts E₁, E₂, E₃, E₄, E₅, and E₆, respectively. Not all experts perform equally well. Each expert may be rated by a score, which may be a probability representing the accuracy of the expert's result. In some embodiments, a very low score may be considered as not representing an expert and corresponding to a non-expert. In some embodiments, all subnetworks represent experts. This evaluation may be performed on a per layer basis such that a layer may have an expert set different from other layers. For example, as shown in FIG. 3 and will be explained in the following, layer 1 may have the expert set 192₁ (E₁, E₄), layer 2 may have the expert set 192₂ (E₃, E₅), and layer 3 may have the expert set 192₃ (E₁, E₅).

The “expertise” of an expert is further divided into two categories: hot and cold. A hot expert performs well. It may have a performance index exceeding a performance standard. The performance index may be a normalized score or a probability of accuracy. The performance standard may be a predefined threshold. A cold expert does not perform well enough. It's performance index may be below the performance standard. Alternatively, the classification may be based on a ranking order within the corresponding layer. The top k experts with the highest performance may be considered hot experts and the rest is considered cold. The value k may be determined empirically or by experiments. For example, if k=2, then the top 2 experts are considered hot experts, and the rest are cold experts. Experts in a layer may be the same or different from experts in another layer depending on how the training and the data are progressed through. In some embodiments, the evaluation of the expert performance may be carried out by a gating network. The gating network may be a simple neural network with a linear layer. The gating network may analyze the input and compute the score for each expert.

For example, the subnetworks E₁ and E₄ are hot experts, designated in a dark shade. The expert E₁ includes the elements A, B, and G. The expert E₄ includes the elements A, E, and G. The subnetworks E₃ and E₅ are cold experts, shown in a cross-hatched pattern. The expert E₃ includes the elements A, D, and G. The expert E₅ includes the elements A, F, and G. The subnetwork E₂ is non-expert, shown in white. The non-expert E₂ includes the elements A, C, and G. A group 360 of the experts E₁, E₄, E₃, and E₅ are an MoE. Each expert is a subnetwork as illustrated in subnetwork 370. Once selected, the selected expert sets are enabled or activated during the inference phase while the non-selected experts are disabled or deactivated during the inference phase.

In some embodiments, each layer in the layer set 190 has a selected expert set including hot experts. The number of experts in a selected expert ser is the same for all layers to simplify the control, activation, and management. When a layer receives the expert set, it will perform its inference or processing using only the expert in the selected expert set, and not the entire expert set. That way, the computational resources including memory utilization will be significantly reduced. For example, there are 5 experts in the entire expert set. Suppose there are three layers in the layer set 190. Each layer has 2 selected experts as follows. Layer 1 has E₁ and E₄. Layer 2 has E₃ and E₅. Layer 3 has E₁ and E₅. Each layer is then configured to have only two experts or two subnetworks, instead of all five experts or the entire network. The savings in computational resources are quite significant.

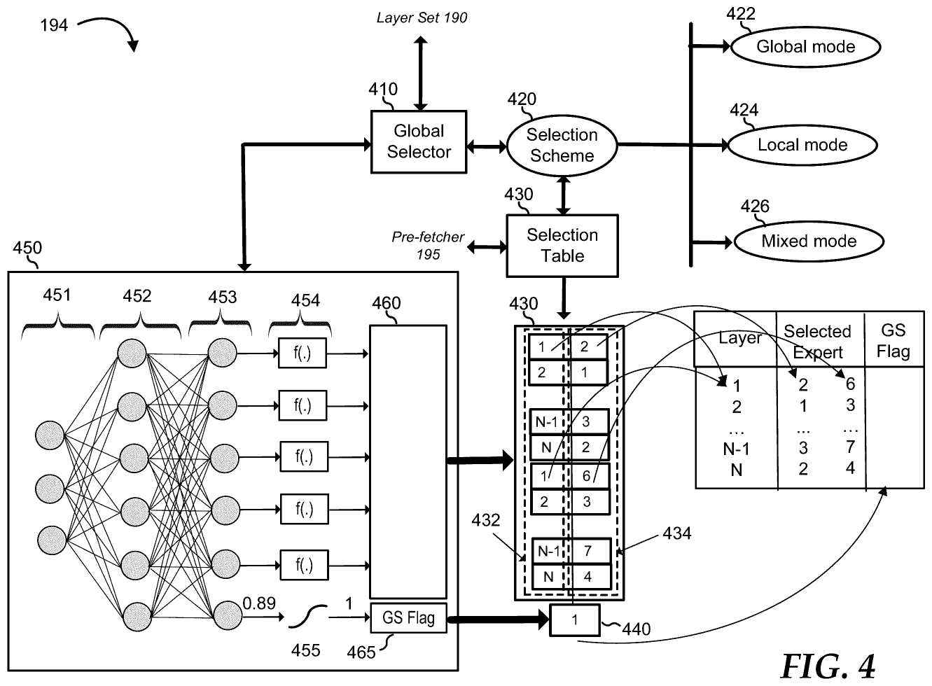

FIG. 4 is a diagram illustrating the expert selector 194 shown in FIG. 1 according to an embodiment. The expert selector 194 may be implemented as a function that is performed by the processor 188 or a stand-alone unit. It includes a global selector 410, a selection table 430, and a selection training network 450. The expert selector 194 may include more or less than the above components.

The global selector 410 is configured as a manager of a selection scheme 420 to select the experts from the MoE. The selection scheme 420 include at least three selection modes: a global mode 422, a local mode 424, and a mixed mode 426. The selection scheme 420 may be based on at least one of an operational standard, a performance metric, a utilization metric, or a context metric. The operational standard may refer to criteria of performance of the LLM in a particular application or environment. The performance metric may be based on the probability as analyzed by an evaluation of each expert. The utilization metric may be based on the effectiveness of the resource utilization such as computational resources and memory resources. The context metric refers to a measurement of how the experts perform in a particular context (e.g., travel reviews).

The selection table 430 is configured to store the set-up or configuration of the selection mode. It includes at least two fields: layer field 432 and expert field 434. The layer field 432 includes the layer identifier (ID). The layer ID may be 1 through N. The expert field 432 shows the selected expert. In one embodiment, the selected expert is a hot expert. A layer may have multiple selected experts. A row corresponds to a layer and an expert in that layer. For N layers, there will be N rows. If each layer has K experts, there will be N×K rows. In the example shown in FIG. 4, the MoE has eight experts. From these eight experts, there are two hot experts in each layer. Table 430 stores the layer and expert identifiers. For example, layer 1 has experts 2 and 6, layer 2 has experts 1 and 3, layer N-1 has experts 3 and 7, and layer N has experts 2 and 4. The total number of rows is 2N. A flag 440 indicates whether the mode for a layer is global or local. For example, a value of 1 indicates a global mode, a value of 0 indicates a local mode. In one embodiment, each layer has its own selection mode. For a global mode, all layers use the global selectors with the table 430 and the corresponding flag values for all layers are 1. The table 430 is valid only for global mode because for local mode, each layer has its own selection table inside itself. For a local mode, all layers use the local selectors and the corresponding flag values for all layers are 0. For a mixed mode, each layer has a corresponding flag value, 1 for global and 0 for local. Accordingly, the table 430 may be configured to have three fields: the layer field 432, the expert filed 434, and a mode field 440.

The selection training network 450 is a network to train the selection process. In some embodiments, it is configured as a multi-layer perceptron (MLP). It may be used in the global mode or the local mode. In the illustrative diagram in FIG. 4, the selection training network 450 has two layers. There are five vectors: input vector 451, hidden vector 452, output vector 453, shaping vector 454, and result vector 460. The number of elements in the result vector 460 matches the number of rows in the table 430. The result vector 460 may be configured to have the positions of its components corresponding to the layer identifier so that the result vector 460 maps to the table 430. An function 455 is used to shape the result for the global selector (GS) flag 465. In one embodiment, the function 455 is a sigmoid. The output of the sigmoid function is either 1 (for global mode) or 0 (for local mode). The function 455 therefore acts as a thresholder. It compares the input value with a threshold (e.g., 0.5). If the input value is above 0.5 (e.g., 0.89), it produces a 1. If the input value is equal to or less than the threshold, it produces a 0. The shaping vector 454 operates in a similar manner. It includes a number of functions that shape the values of the output vector 453 to correspond to the expert identifiers. The shaping function may be any one of the following functions: sigmoid, tanh (hyperbolic tangent), ReLU (rectified linear unit), leaky ReLU, parametric ReLU, and softmax. Additional mapping function may be employed to ensure that the result corresponds to the range of the expert identifiers (e.g., 1, 2, . . . , 8).

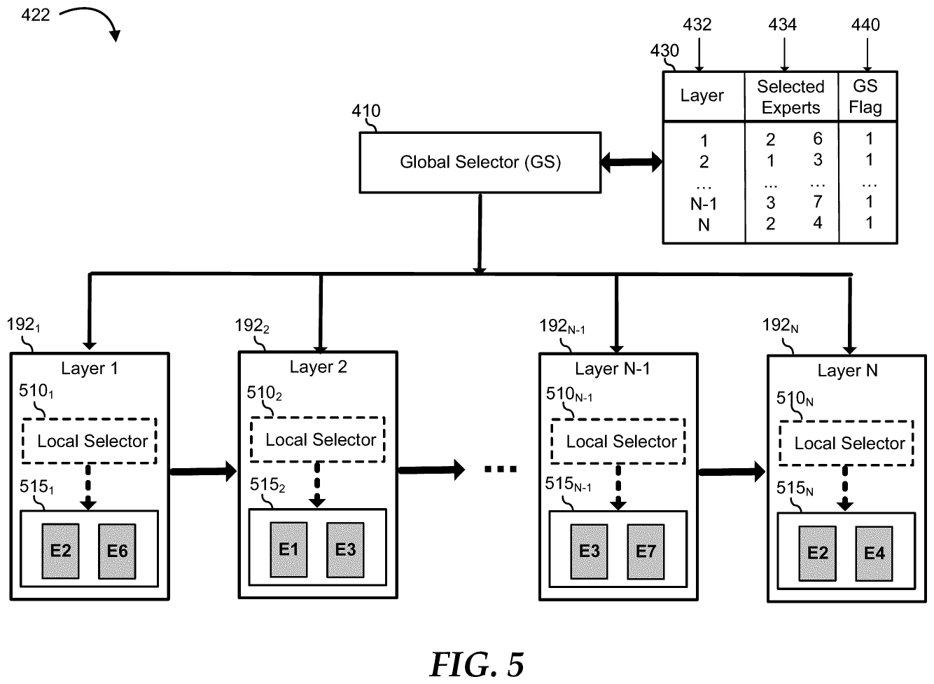

FIG. 5 is a diagram illustrating an expert selection with the global mode 422 according to an embodiment. In the global mode, the local selectors in the layers are not used. The global selectors 410 perform the selection of experts for all layers all at once. The training for the selection of experts is based on the MLP 450 shown in FIG. 4. Since all experts are selected at the same time and prior to the inference phase, the global mode is efficient. Each layer will be installed with the experts selected by the global selector 410.

In the example shown in FIG. 5, the global selector selects the experts as shown in the table. Layer 1 has experts 2 and 6. Layer 2 has experts 1 and 3. Layer N-1 has experts 3 and 7. Layer N has experts 2 and 4. The GS flag 440 is all 1 for all layers. The local selectors in the layers are not used and are shown in dashed lines. Since the local selectors are not used, the experts in each layer are the experts selected by the global selector 410.

The layer 1, layer 192₁, has a local selector 510₁ and the expert set 515₁. This expert set is inside the layers so that the layer can perform its inference function. But since the experts are selected by the global selector 410, this expert set will be referred to as a global expert set 515₁ having the hot experts E₂ and E₆. This is to distinguish from the local expert sets, also reside inside the layers, selected by the local selectors. Similarly, the layer 2, layer 192₂, has a local selector 510₂ and the global expert set 515₂ having the hot experts E₁ and E₃. The layer N-1, layer 192_{N-1}, has a local selector 510_{N-1} and the global expert set 515_{N-1} having the hot experts E₃ and E₇. The layer N, layer 192_{N}, has a local selector 510_{N} and the global expert set 515_{N} having the hot experts E₂ and E₄.

Accordingly, the global selector 410 is configured to manage the selection scheme 420 having at least the global mode 422. In the global mode, the global selector 410 selects a global expert set from a mixture of experts (MoE) to generate a selected global expert set for each layer for the entire layer set 190 prior to an inference phase in a ML model. The pre-fetcher 195 pre-fetches in the global mode 422 the selected global expert set from a first memory into a second memory. The selected global expert set includes one or more global hot experts.

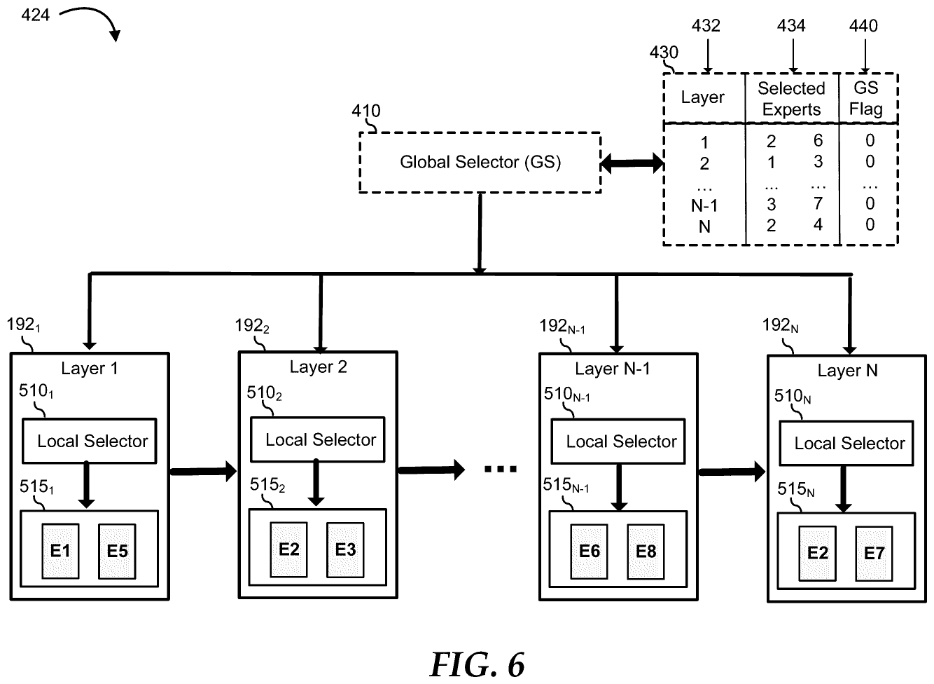

FIG. 6 is a diagram illustrating an expert selection with a local mode according to an embodiment. In the local mode, the global selector 410 and the table 430 are not used. Therefore, they are shown in dashed lines. The individual local selectors in the corresponding layers perform the selection of experts sequentially according to the sequential order of the layers. The training for the selection of experts is based on the MLP 450 shown in FIG. 4. Since all experts are selected sequentially but prior to the inference phase in each layer, the local mode is not as efficient as the global mode. However, since each local selector operates its selection training on the fly, its accuracy may be better than the global mode. Each layer will be installed with the experts selected by its local selector 510ⱼ (j=1, . . . , N).

In the example shown in FIG. 6, the global selector 410 and the table 430 are not used and therefore they are shown with dashed lines. Each local selector selects the experts as shown in its local selected expert set. The layer 1, layer 192₁, has a local selector 510₁ and the local expert set 515₁ having the local hot experts E₁ and E₅. The layer 2, layer 192₂, has a local selector 510₂ and the local expert set 515₂ having the local hot experts E₂ and E₃. The layer N-1, layer 192_{N-1}, has a local selector 510_{N-1} and the local expert set 515_{N-1} having the local hot experts E₆ and E₈. The layer N, layer 192_{N}, has a local selector 510_{N} and the local expert set 515_{N} having the local hot experts E₂ and E₇.

Accordingly, in the local mode, each layer selects a local expert set from the MoE to generate a selected local expert set in the inference phase. The selected local expert set includes one or more local hot experts. The pre-fetcher prefetches the selected local expert set for each layer for the entire layer set from the first memory into the second memory prior to the inference phase.

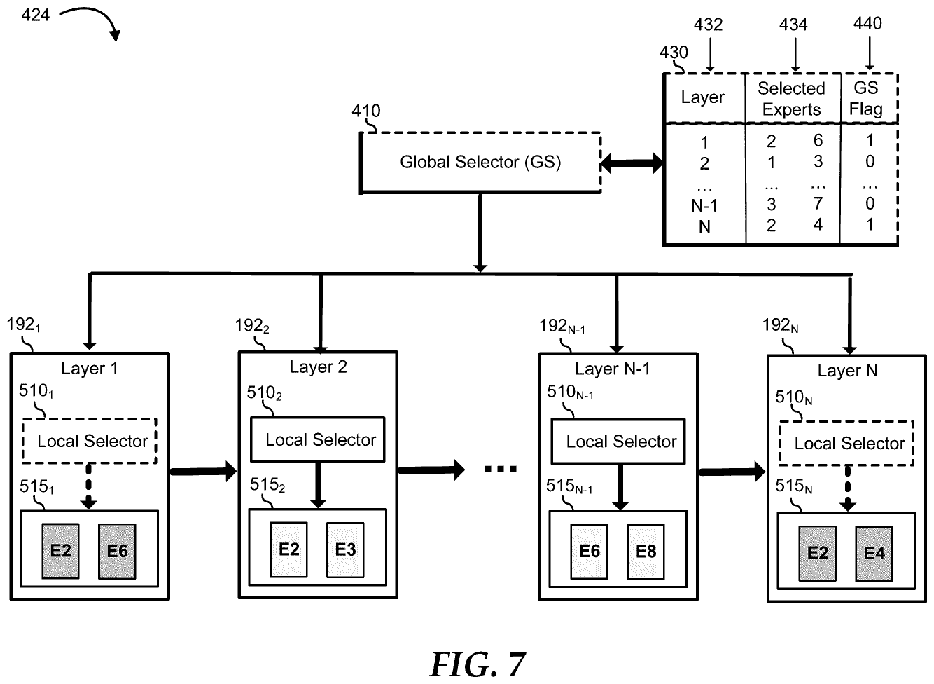

FIG. 7 is a diagram illustrating an expert selection with a mixed mode according to an embodiment. In the mixed mode, the global selector 410 and the table 430 may be used depending on the configuration. The selection flag 440 is used to indicate which mode a layer is associated with. A layer may use a global mode in which case the experts selected in table 430 for that layer will be used, or a local mode, in which case the experts selected in table 430 for that layer will not be used. When in the local mode, a layer will used the local expert sets as selected by itself. Since the global selector 410 and the table 430 may or may not be used, they are shown partially in dashed lines. When a layer is used in local mode, it will follow the process described in FIG. 6 and the layer will be installed with the experts selected by its local selector 510ⱼ (j=1, . . . , N).

In the example shown in FIG. 7, layers 1 and N uses global mode and layers 2 and N-1 use local mode as shown by the GS flag field 440. The layer 1, layer 192₁, has a local selector 510₁ unused and its expert set 515₁ is a global expert set having the global hot experts E₂ and E₆. The layer 2, layer 192₂, has a local selector 510₂ and the local expert set 515₂ having the local hot experts E₂ and E₃. The layer N-1, layer 192_{N-1}, has a local selector 510_{N-1} and the local expert set 515_{N-1} having the local hot experts E₆ and E₈. The layer N, layer 192_{N}, has a local selector 510_{N} unused and its expert set 515_{N} is a global expert set having the global hot experts E₂ and E₄.

Accordingly, in the mixed mode, each layer 192ⱼ selects one of the global expert set or the local expert set to generate a selected one of the global expert set or the local expert set for each layer according to a selection flag associated with the each layer prior to the inference phase. The selected expert set (global or local) includes one or more hot experts (global or local). The pre-fetcher 195 prefetches the selected expert set (global or local) for each layer for the entire layer set from the first memory into the second memory prior to the inference phase.

FIG. 8 is a diagram illustrating a pre-fetch process 800 according to an embodiment. The pre-fetch process 800 involves the pre-fetcher 195 and the tiered memory 197 shown in FIG. 1. The pre-fetcher 195 and the tiered memory 197 may be part of the processing system 188 or a separately configured unit.

The pre-fetcher 195 is a circuit or a function that reads data from a lower-tiered memory and write the data to a higher-tiered memory prior to the inference phase. The objective of pre-fetching is to populate the higher-tiered with only the selected experts instead of the entire FFNN to allow the use of the more costly but higher performance memory.

The tiered memory 197 includes N tiers of memory: tier-1 memory 810₁, tier-j memory 810ⱼ, . . . , and tier-K memory 810_{K}. The tiers refer to the quality or performance of the memory. Lower tiers have lower performance. The main performance factor is the speed. Therefore, the tiered memories range from slow memory to fast memory. Examples of slow memories include low power double data rate dynamic random-access memory (LPDDR DRAM). Examples of fast memories include high-bandwidth memory (HBM).

As an example, memory 820 is a lower-tiered memory (e.g., slow) and memory 830 is a higher-tiered memory (e.g., fast). Since the higher-tiered memory tends to be more costly, it may not be available in large sizes in the system. Therefore, it is desirable to use the higher-tired memory 830 with as small amounts as possible. Suppose the slow memory 820 stores eight experts from E₁ to E₈. Suppose the selected experts are E₂ and E₆. The pre-fetcher 195 fetches E₂ from the slow memory 820 and transfer it to the fast memory 830 through the pre-fetch path 843. The pre-fetcher 195 then fetches E₆ from the slow memory 820 and transfer it to the fast memory 830 through the pre-fetch path 845. After pre-fetching, the layers can access the fast memory 830 during the inference phase, thereby achieving high performance.

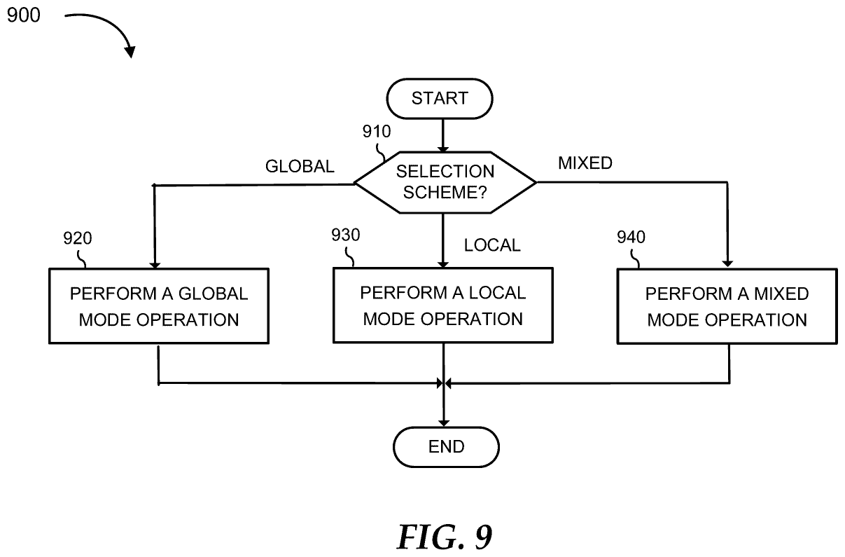

FIG. 9 is a flow chart illustrating a process 900 of expert selection according to an embodiment. The process 900 may be performed by the expert selector 194 or the processor 188 shown in FIG. 1.

Upon START, the process 900 determines what selection scheme is being selected or decided (Process 910). The selection scheme may be based on at least one of an operational standard, a performance metric, a utilization metric, or a context metric. This decision may be made as part of a configuration file or by input from the user 180 shown in FIG. 1. Alternatively, the choice of which selection scheme may be adaptive according to the system performance or other feedback information. There are three schemes to be selected: a global mode, a local mode, and a mixed mode.

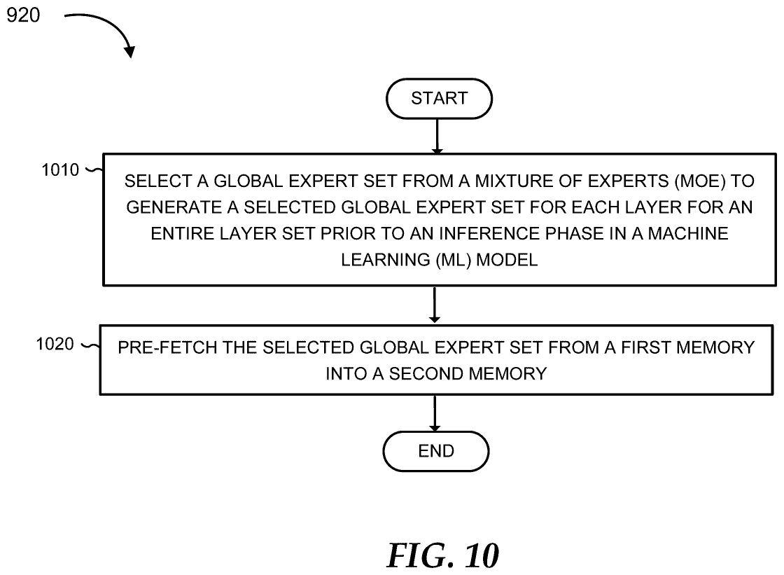

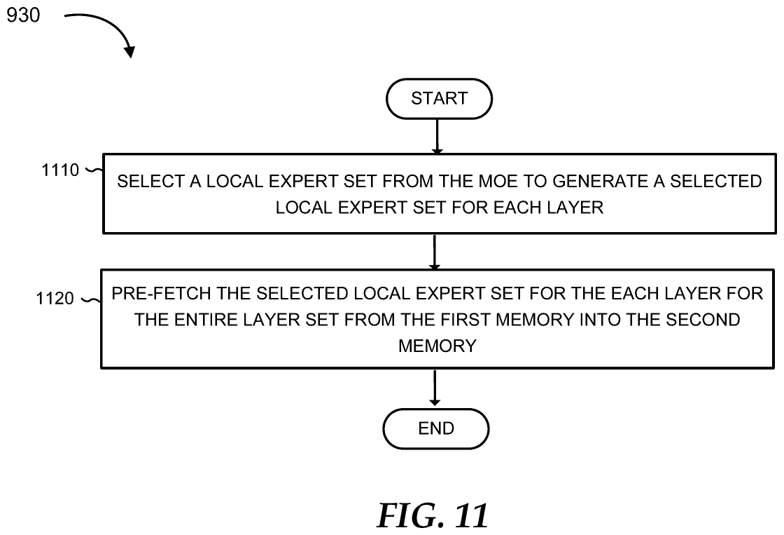

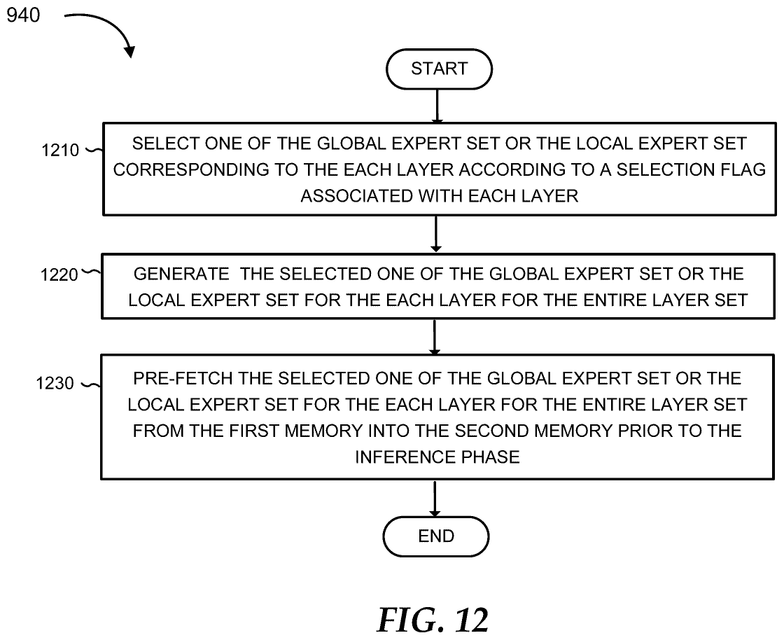

If the selection scheme is the global mode, the process 900 performs a global mode operation (Process 920). The process 920 will be described in FIG. 10. The process 900 is then terminated. If the selection scheme is the local mode, the process 900 performs a local mode operation (Process 930). The process 930 will be described in FIG. 11. The process 900 is then terminated. If the selection scheme is the mixed mode, the process 900 performs a mixed mode operation (Process 940). The process 940 will be described in FIG. 12. The process 900 is then terminated.

FIG. 10 is a flow chart illustrating the process 920 of expert selection in the global mode according to an embodiment. The global mode is described in FIG. 5. Each layer includes a subnetwork set of a feedforward neural network (FFNN).

Upon START, the process 920 selects a global expert set from a mixture of experts (MoE) to generate a selected global expert set for each layer for an entire layer set prior to an inference phase in an ML model (Process 1010). The selection may be made based on an evaluation process that evaluates the score of each expert for a given input. The selection of the global expert set may be based on a ranking of all experts in the MoE. For example, the process 1010 may store the selected global expert set for the each layer for the entire layer set in a table. This corresponds to the table 439 shown in FIG. 5. The selected global expert set includes one or more global hot experts such as the expert sets 515₁ to 515_{N} shown in FIG. 5. The one or more global hot experts have a global performance index exceeding a global performance standard as determined by the evaluation process. The one or more global hot experts are activated during the inference phase.

The process 920 then pre-fetches the selected global expert set from a first memory into a second memory (Process 1020). In one embodiment, the first memory and the second memory are organized in a tiered memory arrangement where the first memory is a slow memory, and the second memory is a fast memory. The process 920 is then terminated.

FIG. 11 is a flow chart illustrating the process 930 of expert selection in a local mode according to an embodiment. The local mode is described in FIG. 6. Each layer includes a subnetwork set of a feedforward neural network (FFNN).

Upon START, the process 930 selects a local expert set from a mixture of experts (MoE) to generate a selected local expert set for each layer for an entire layer set prior to an inference phase in an ML model (Process 1110). The selection may be made based on an evaluation process that evaluates the score of each expert for a given input. The selection of the local expert set may be based on a ranking of all experts in the MoE. The selected local expert set includes one or more local hot experts such as the expert sets 515₁ to 515_{N} shown in FIG. 6. The one or more local hot experts have a local performance index exceeding a local performance standard as determined by the evaluation process. The global expert set and the table are not used.

The process 920 then pre-fetches the selected local expert set from a first memory into a second memory (Process 1120). In one embodiment, the first memory and the second memory are organized in a tiered memory arrangement where the first memory is a slow memory and the second memory is a fast memory. The process 930 is then terminated.

FIG. 12 is a flow chart illustrating the process 940 of expert selection in a mixed mode according to an embodiment. The mixed mode is described in FIG. 7. Each layer includes a subnetwork set of a feedforward neural network (FFNN).

Upon START, the process 940 selects, by each layer, one of the global expert set or the local expert set corresponding to each layer and according to a selection flag associated with each layer (Process 1210). The selection flag may indicate a global or local mode for a layer. If the flag indicates a global mode (e.g., flag =1), the process 940 obtains the experts from the table. If the flag indicates a local mode (e.g., flag =0), the process 940 obtains the experts from the local selector of that layer.

Next, the process 940 generates the selected one of the global expert set or the local expert set for the each layer for the entire layer set (Process 1220). Then, the process 940 pre-fetches the selected one of the global expert set or the local expert set for the each layer for the entire layer set from the first memory into the second memory prior to the inference phase (Process 1230). The prefetched expert sets will be used by each layer during inference phase. The process 940 is then terminated.

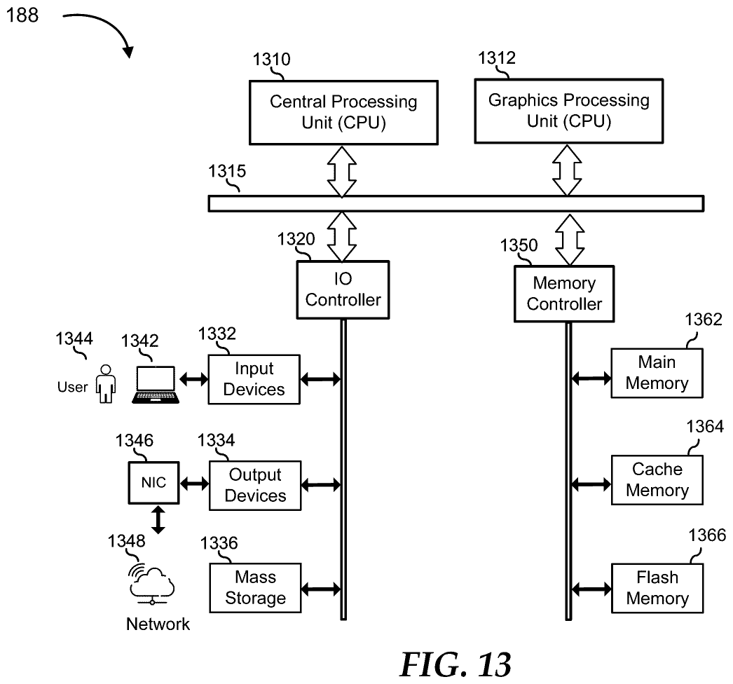

FIG. 13 is a diagram illustrating the processor or processing system 188 shown in FIG. 1 according to an embodiment. The processor or processing system 188 may perform functions or operations described above, including the flowcharts in FIGS. 9 through 12. The processor or processing system 188 includes a central processing unit (CPU) 1310, a graphics processing unit (GPU) 1312, an input/output (IO) controller 1320, and a memory controller 1350. The processor or processing system 188 may include more or less than the above components. In addition, a component may be integrated into another component. The integration may be partial and/or overlapped. For example, the memory controller 1350 and the I/O controller 1320 may be integrated into one single controller.

The CPU 1310 is a programmable device that may execute a program or a collection of instructions to carry out a task. It may be a host that controls or manages other processors or devices. In particular, the CPU 1310 may include applications programming interfaces (APIs), applications, or drivers that are executed by the CPU 1310 to perform specified tasks. The CPU 1310 may be a general-purpose processor, a digital signal processor, a microcontroller, or a specially designed processor. It may include a single core or multiple cores. Each core may have multi-way multi-threading. The CPU 1310 may have simultaneous multithreading feature to further exploit the parallelism due to multiple threads across the multiple cores. In addition, the CPU 1310 may have internal caches at multiple levels.

The GPU 1312 is a specialized processor designed to perform computationally intensive tasks such as image analysis, graphics rendering, and neural computations. In addition, the GPU 1312 may be designed with parallel processing capability, suitable for parallel computations in artificial intelligence (AI) applications including machine learning (ML), large language model (LLM), and neural networks (NN). The GPU 1312 may be used to accelerate training and running AI models. It may include multiple computational accelerators or tensor cores which are optimized for basic AI computations such as matrix multiply-accumulate operations.

The CPU 1310 and the GPU 1312 communicate with other devices in the system via a bus 1315. The bus 1315 may be any suitable bus connecting the CPU 1310 and the GPU 1312 to other devices. For example, the bus 1315 may be a Direct Media Interface (DMI). The bus 1315 may also include other custom buses such as bus for the interface to the analog section when the system 188 is used as a mobile device.

The I/O controller 1320 controls input devices 1332, output devices 1334, and mass storage 1336. The input devices 1332 may include a keyboard, a mouse, an image sensor or camera, a game console, and a microphone. Other input devices may also be available such as stylus, joystick, scanner, and light pen. The input devices may also have a user interface to interface to a computer or laptop 1342 and/or a user 1344. The output devices 1334 may include a printer, a monitor or screen, a headset, and a multi-monitor set. When used as a computing device without mobile features, the monitor is a high-resolution display. For games and other multi-display mode, the multi-monitor set provides high-resolution with multiple monitors (e.g., three monitors). When used for mobile communication, the screen provides the primary interface for the user to navigate, access various applications and perform tasks. The screen may use organic light-emitting diode (OLED) (super retina) display with multi-touch or haptic touch feature. The output devices 1334 also include a network interface card (NIC) 1346 which provides an interface to a network and wireless medium 1348. The mass storage 1336 may include CD-ROM, hard disk, and solid-state drives (SSDs).

The memory controller 1350 controls memory devices such as a main memory 1362, a cache memory 1364, and a flash memory 1366. The main memory 1362 includes random access memory (RAM) including static RAM (SRAM) and dynamic RAM (DRAM) and/or the read-only memory (ROM) and other types of memory. The DRAM may include Synchronous DRAM (SDRAM), Double Data Rate SDRAM (DDR SDRAM) with variations (e.g., DDR2, DDR3, DDR4, DDR5, and DDR6). The main memory 1362 may store instructions or programs, loaded from a mass storage device, that, when executed by the CPU 1310, cause the CPU 1310 to perform operations for a specified task. It may also store data used in the operations. The ROM may be a solid-state drive (SSD) and include instructions, programs, constants, or data that are maintained whether it is powered or not. The instructions or programs may correspond to the functionalities described above. In one embodiment, the main memory 1362 includes a 3D memory device or circuit such as VSDRAM and V-NAND flash memory, or any other memory devices that have memory cells that are stacked vertically to increase storage density

Additional devices or bus interfaces may be available for interconnections and/or expansion. Some examples may include the Peripheral Component Interconnect Express (PCIe) bus, the Universal Serial Bus (USB), etc.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A device comprising:
a global selector configured to manage a selection scheme having at least one of a global mode or a local mode, wherein in the global mode the global selector selects a global expert set from a mixture of experts (MoE) to generate a selected global expert set for each layer prior to an inference phase in a machine learning (ML) model; and
a pre-fetcher configured to pre-fetch in the global mode the selected global expert set from a first memory into a second memory,
wherein the selected global expert set includes one or more global hot experts.

2. The device of claim 1, wherein the first memory and the second memory are organized in a tiered memory arrangement.

3. The device of claim 1,
wherein in the local mode, the each layer selects a local expert set from the MoE to generate a selected local expert set in the inference phase,
wherein the selected local expert set includes one or more local hot experts, and
wherein the pre-fetcher prefetches the selected local expert set for the each layer for the entire layer set from the first memory into the second memory prior to the inference phase.

4. The device of claim 3,
wherein the selection scheme further includes a mixed mode,
wherein in the mixed mode, each layer selects one of the global expert set or the local expert set for each layer according to a selection flag associated with the each layer and generates the selected one of the global expert set or the local expert set for the each layer for the entire layer set prior to the inference phase, and
wherein in the mixed mode, the pre-fetcher prefetches the selected one of the global expert set or the local expert set for the each layer for the entire layer set from the first memory into the second memory prior to the inference phase.

5. The device of claim 1, further comprising:
a table configured to store the selected global expert set for the each layer for the entire layer set, and
wherein the pre-fetcher pre-fetches in the global mode the selected global expert set using the table.

6. The device of claim 1, wherein the MoE in the each layer includes a subnetwork set of a feedforward neural network (FFNN).

7. The device of claim 1,
wherein the one or more global hot experts have a global performance index exceeding a global performance standard, and
wherein the one or more global hot experts are activated during the inference phase.

8. The device of claim 3, wherein the one or more local hot experts have a local performance index exceeding a local performance standard.

9. The device of claim 4, wherein the selection scheme is based on at least one of an operational standard, a performance metric, a utilization metric, or a context metric.

10. The device of claim 2, wherein the first memory is a slow memory and the second memory is a fast memory.

11. A method comprising:
selecting, in a global mode of a selection scheme, a global expert set from a mixture of experts (MoE) to generate a selected global expert set for each layer for an entire layer set prior to an inference phase in a machine learning (ML) model; and
pre-fetching, in the global mode, the selected global expert set from a first memory into a second memory,
wherein the selected global expert set includes one or more global hot experts.

12. The method of claim 11, wherein the first memory and the second memory are organized in a tiered memory arrangement.

13. The method of claim 11, further comprising:
selecting, by the each layer in a local mode of the selection scheme, a local expert set from the MoE to generate a selected local expert set; and
pre-fetching, in the local mode, the selected local expert set for the each layer for the entire layer set from the first memory into the second memory,
wherein the selected local expert set includes one or more local hot experts.

14. The method of claim 13, further comprising:
selecting, by the each layer in a mixed mode of the selection scheme, one of the global expert set or the local expert set corresponding to the each layer according to a selection flag associated with the each layer;
generating, in the mixed mode, the selected one of the global expert set or the local expert set for the each layer for the entire layer set, and
pre-fetching, in the mixed mode, the selected one of the global expert set or the local expert set for the each layer for the entire layer set from the first memory into the second memory prior to the inference phase.

15. The method of claim 11, further comprising:
storing the selected global expert set for the each layer for the entire layer set in a table, and
pre-fetching, in the global mode, the selected global expert set using the table.

16. The method of claim 11, wherein the MoE in the each layer includes a subnetwork set of a feedforward neural network (FFNN).

17. The method of claim 11,
wherein the one or more global hot experts have a global performance index exceeding a global performance standard, and
wherein the one or more global hot experts are activated during the inference phase.

18. The method of claim 13, wherein the one or more local hot experts have a local performance index exceeding a local performance standard.

19. The method of claim 14, wherein the selection scheme is based on at least one of an operational standard, a performance metric, a utilization metric, or a context metric.

20. A system comprising:
an input token generator configured to generate an input token set;
a layer set configured to process the input token set;
an expert selector comprising:
a global selector configured to manage a selection scheme having at least one of a global mode or a local mode, wherein in the global mode the global selector selects a global expert set from a mixture of experts (MoE) to generate a selected global expert set for each layer for an entire layer set prior to an inference phase in a machine learning (ML) model, the global selector generating a selected global expert set for the each layer for the entire layer set; and
a pre-fetcher configured to pre-fetch in the global mode the selected global expert set from a first memory into a second memory,
wherein the selected global expert set includes one or more global hot experts.
